(19) United States
(12) Patent Application Publication
(10) Pub. No.: US 2016/0033345 A1
(43) Pub. Date: Feb. 4, 2016

(54) APPARATUS FOR MEASURING LOAD APPLIED TO SEAT

(71) Applicant: Honda Motor Co., Ltd., Tokyo (JP)

(72) Inventors: Toshihiro Koike, Wako-shi (JP); William Seaman, Torrance, CA (US)

(21) Appl. No.: 14/449,465

(22) Filed: Aug. 1, 2014

(51) Int. Cl. G01L 1/22

(52) U.S. Cl. CPC G01L 1/2281

(57) ABSTRACT

An apparatus 10 for measuring a load applied to a seat includes a load sensor 11 furnished to the seat 20 and capable of outputting a load applied to the seat 20 and a seat 20 weight; a temperature detection unit 12 for detecting a temperature of the load sensor 11; and an applied load value determination unit 13 for determining a load applied to the seat 20, according to an output value of the load sensor 11. The applied load value determination unit 13 of the apparatus 10 for measuring a load applied to a seat determines a value relating to a load initially applied to the seat 20, based on the output value of the load sensor 11 when the temperature of the load sensor 11 is within a first temperature range including a predetermined temperature.

### FIELD OF THE DISCLOSURE

The present disclosure relates to an apparatus for measuring a load applied to a seat, on the basis of a value relating to a load initially applied to the seat. In particular, the present disclosure relates to an apparatus for determining a value relating to a load initially applied to a seat when the temperature of the load sensor is, for example, within a predetermined temperature range.

### BACKGROUND OF THE DISCLOSURE

Japanese Patent No. 4048976, for example, discloses an apparatus for measuring a load applied to a seat, the apparatus being provided with load sensors furnished to the seat and a calculating unit for calculating the load applied to the seat. The calculating unit of the apparatus disclosed in Japanese Patent No. 4048976 updates a value relating to the load initially applied to the seat, doing so on the basis of detected values from the load sensors. In this instance, the value relating to the load initially applied to the seat is a load value applied to the seat when no passenger is sitting in the seat, and when no object has been placed thereon.

This calculating unit updates the value relating to the load initially applied to the seat, at a time at which it is expected that no passenger is sitting in the seat, at which time the seat belt of the vehicle is not fastened. The calculating unit acquires output values from the load sensors at times at which the seat belt of the vehicle is not fastened. Using the output values acquired from the load sensors as a reference for the previously updated value relating to the load initially applied to the seat, the calculating unit carries out a predetermined filtering process on the output values acquired from the load sensors when these values lie within a predetermined range. The calculating unit then updates the value relating to the load initially applied to the seat using the value obtained by carrying out the filtering process.

Japanese Patent No. 4048976 does not disclose a value relating to a load initially applied to the seat determined as soon as possible after the seat has been attached to the vehicle. However, the inventors have found that in order to accurately update the value relating to the load initially applied to the seat, it is crucial to accurately determine the value relating to the load initially applied to the seat after the seat is attached to the vehicle.

### SUMMARY OF THE DISCLOSURE

One object of the present disclosure is to provide an apparatus for measuring a load applied to a seat, the apparatus determining a value relating to the load initially applied to the seat when the temperature of a load sensor is within a predetermined temperature range. Other objects of the present disclosure will be apparent to a person skilled in the art by reference to the embodiments described below, the preferred embodiments, and the accompanying drawings.

According to a first aspect, there is provided an apparatus for measuring a load applied to a seat, the apparatus comprising:

a load sensor furnished to the seat, and capable of outputting the load and a weight of the seat;

a temperature detection unit for detecting a temperature of the load sensor; and

an applied load value determination unit for determining a load applied to the seat, according to an output value of the load sensor,

the applied load value determination unit determining a value relating to a load initially applied to the seat, based on the output value of the load sensor when the temperature of the load sensor is within a first temperature range including a predetermined temperature.

Load sensors typically have temperature characteristics such that the output value of the load sensor fluctuates according to changes in temperature of the load sensor. For this reason, an error may occur in the value relating to the load initially applied to the seat, depending on the temperature of the load sensor when a value relating to the load initially applied to the seat is determined. To solve this issue, the applied load value determination unit determines a value relating to the load initially applied to the seat on the basis of an output value of the load sensor when the temperature of the load sensor is within a first temperature range. As a result, the applied load value determination unit is able to determine an accurate value relating to the load initially applied to the seat (a reduced-error value relating to the load initially applied to the seat). Consequently, the apparatus can accurately measure the load applied to the seat while a passenger is seated in the seat.

According to a second aspect, there is provided an apparatus according to the first aspect, wherein

when the detected temperature of the load sensor lies within a second temperature range, which includes the first temperature range and within which association of temperatures of the load sensor and output values of the load sensor is possible throughout the entire range, the applied load value determination unit

predicts an output value of the load sensor in the event that the temperature of the load sensor is at the predetermined temperature, or lies within the first predetermined temperature range, and

determines a value relating to a load initially applied to the seat, based on the predicted output value of the load sensor.

In the second aspect, the applied load value determining unit can accurately determine a value relating to a load initially applied to the seat, even when the temperature of the load sensor does not lie within the first temperature range. As a result, even at times when the temperature of the load sensor does not lie within the first temperature range, it is unnecessary, for example, for the operator to wait until the temperature of the load sensor reaches a predetermined temperature, or enters the first temperature range, in order to initiate an operation to determine a value relating to a load initially applied to the seat. Consequently, the time required for the operation to determine a value relating to a load initially applied to the seat can be reduced.

According to a third aspect, there is provided an apparatus according to the second aspect, wherein the applied load value determining unit, by employing a computational formula or table by which association of temperatures of the load sensor and output values of the load sensor is possible, predicts an output value of the load sensor in the event that the temperature of the load sensor is at the predetermined temperature, or lies within the first predetermined temperature range.

In the third aspect, the applied load value determining unit employs a table or a computational formula, making it possible to prevent an increase in the amount of processing in relation to predicting an output value of the load sensor when the temperature of the load sensor is at the predetermined temperature, or lies within the first predetermined temperature range.

According to a fourth aspect, there is provided an apparatus according to the first aspect, wherein subsequent to attachment of the seat to a vehicle, the applied load value determining unit determines a value relating to a load initially applied to the seat, based on the output value of the load sensor when the temperature of the load sensor is within the first temperature range.

In the fourth aspect. the value relating to a load initially applied to the seat is determined in consideration of fluctuating load when the seat is attached to the vehicle. Therefore, the weight of the passenger can be measured by measuring the load applied to the seat when the passenger is subsequently seated in the seat.

### BRIEF DESCRIPTION OF THE DRAWINGS

Several preferred embodiments will be described in detail below with reference to the accompanying drawings, wherein:

FIG. 1 is a block diagram showing an example of the configuration of an apparatus for measuring a load applied to a seat;

FIG. 2 is a perspective view showing an example of placement of load sensors shown in FIG. 1;

FIG. 3 is a graph showing an example of the relationship between the output value from the load sensors shown in FIG. 1 and the temperature of the load sensors;

FIG. 4 is a flowchart showing an example of operation of the apparatus for measuring a load applied to the seat shown in FIG. 1;

FIG. 5 is a graph showing an example of the relationship between the output value of the load sensors and the temperature of the load sensors in a second embodiment;

FIG. 6 is a flowchart showing an example of operation of the apparatus for measuring a load applied to the seat in the second embodiment;

FIG. 7 is a graph showing an example of the relationship between the output value of load sensors and the temperature of the load sensors in a third embodiment; and

FIG. 8 is a flowchart showing an example of operation of the apparatus for measuring a load applied to the seat in the third embodiment.

### DETAILED DESCRIPTION OF THE PREFERRED EMBODIMENTS

The preferred embodiments described below are employed to facilitate understanding of the disclosure. It should therefore be noted by persons skilled in the art that the disclosure is not unduly limited to the embodiments described below.

### First Embodiment

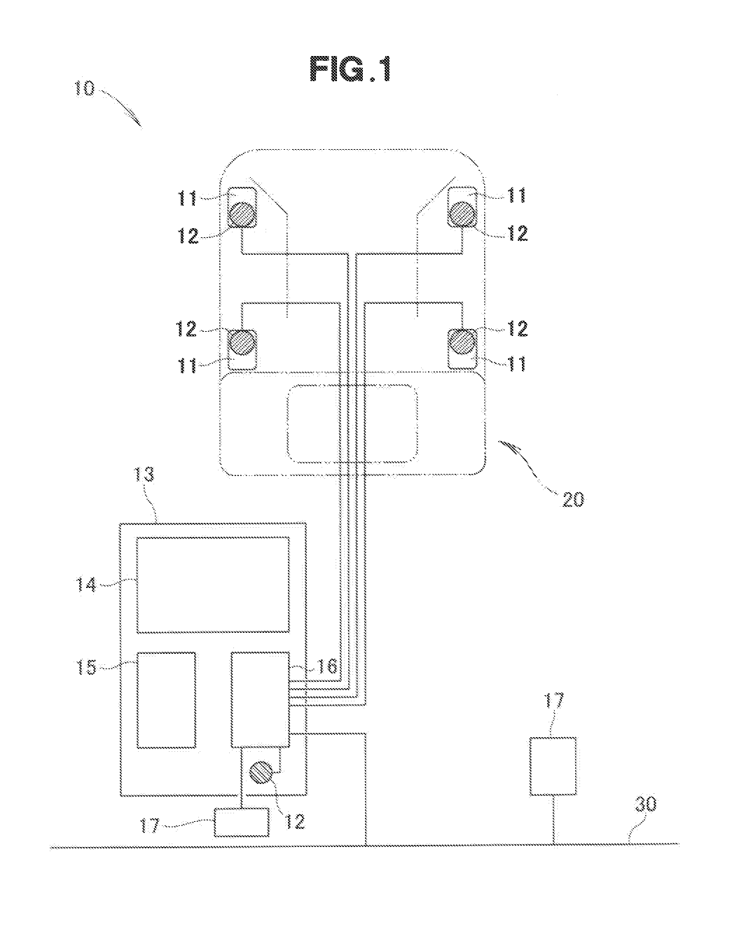

As shown in FIG. 1, an apparatus 10 for measuring a load applied to a seat 20 includes at least one load sensor 11 furnished to the seat 20, at least one temperature detection unit 12, and an applied load value determination unit 13. The applied load value determination unit 13 may be constituted, for example, by a microcomputer having a processing unit 14, a storage unit 15, and an input/output interface unit 16. The applied load value determination unit 13 is connected, for example, through the input/output interface unit 16 to a control area network (CAN) 30, i.e., a local area network (LAN) on board a vehicle. When the applied load value determination unit 13 is connected to the CAN 30, the applied load value determination unit 13 is capable of input and output of signals from and to a communicating unit 17, such as a navigation device display, speaker, indicator, or the like, with which the vehicle is equipped. In this case, the applied load value determination unit 13 is able to input and output signals from and to a seatbelt device, an airbag device, or other such device, or an ECU thereof, not shown.

In the example shown in FIG. 1, the seat 20 is furnished with four load sensors 11. However, the number of load sensors 11 is not necessarily four. That is, the seat 20 may be furnished with five or more of the load sensors 11, or with three or fewer; e.g., the seat 20 may be furnished with two load sensors 11. An example of the placement of the at least one load sensor 11 furnished to the seat 20 will be discussed below.

The load sensors 11 include, for example, a strain-generating body for giving rise to strain proportional to an applied load, and a strain measuring element attached to the strain-generating body, and adapted for measuring the amount of strain of the strain-generating body, none of which are illustrated. The strain measuring element is constituted, for example, such that the electrical resistance value thereof changes in proportion to the magnitude of strain of the strain-generating body. The load sensors 11, for example, measure the electrical resistance value of the strain measuring element in order to measure the load applied to the load sensors 11. The load sensors 11 output the measured load as an output value to the applied load value determination unit 13.

In the example shown in FIG. 1, there are shown a total of five of the temperature detection units 12: the four temperature detection units 12 belonging to each one of the four load sensors 11, and the temperature detection unit 12 belonging to the applied load value determination unit 13. However, the number and locations of the temperature detection units 12 may be different from the example shown in FIG. 1. That is, it is acceptable for only the four load sensors 11 to have the four temperature detection units 12, or for only the applied load value determination unit 13 to have the one temperature detection unit 12. Both the four load sensors 11 and the applied load value determination unit 13 need not have the temperature detection units 12. In this case, the temperature detection units 12 may be temperature detection units 12 dedicated for the apparatus 10, and furnished inside the vehicle but outside of the load sensors 11 and the applied load value determination unit 13, preferably within the passenger compartment, and more preferably in proximity to the seat 20. The temperature detection units 12 may also be temperature detection units 12 concomitantly employed as a temperature detection unit belonging, for example, to an air conditioning device (for example, a temperature detection unit for detecting interior temperature or blown air temperature, i.e., the temperature of the air blown from a blower vent), not shown. When the temperature detection units 12 are not provided to both the load sensors 11 and the applied load value determination unit 13, the dedicated temperature detection units 12 or concomitantly employed temperature detection units 12 are connected to the input/output interface unit 16 of the applied load value determination unit 13, either directly or through the CAN 30. The temperature detection units 12 output the detected temperature to the applied load value determination unit 13.

In the example shown in FIG. 1, the applied load value determination unit 13 is depicted as belonging to the vehicle; however, the unit may be a processing unit constituting operating equipment, not shown, rather than belonging to the vehicle. The operating equipment may include the communicating unit 17 such as a display, speaker, indicator, or the like.

Through the input/output interface unit 16, the applied load value determination unit 13 inputs the output values from the load sensors 11, and the temperatures detected by the temperature detection units 12.

The applied load value determination unit 13 assumes that the temperature input from at least one of the temperature detection units 12 is the temperature of at least one of the load sensors 11. It is also acceptable for the applied load value determination unit 13 to assume that the temperature input from one temperature detection unit 12 from among the plurality of temperature detection units 12 is the temperature of the one load sensor 11 to which that temperature detection unit 12 belongs. When the applied load value determination unit 13 inputs of a plurality of temperatures from the plurality of temperature detection units 12, it is acceptable for the applied load value determination unit 13 to assume that the temperature input from any of the temperature detection units 12 from among the plurality of temperature detection units 12 is the temperature of all of the load sensors 11. Further, when the applied load value determination unit 13 inputs of a plurality of temperatures from the plurality of temperature detection units 12, it is acceptable for the applied load value determination unit 13 to assume that the average value of temperatures input from the plurality of temperature detection units 12 is the temperature of all of the load sensors 11.

When the temperature of the load sensors 11 lies within a first temperature range, discussed below, the applied load value determination unit 13 determines a value relating to a load initially applied to the seat 20, on the basis of the output values of the load sensors 11 at that time. A value relating to a load initially applied to the seat 20 refers to the value of a load applied to the seat 20, when no passenger is sitting in the seat 20, and no object is placed thereon.

The apparatus 10 for measuring a load applied to the seat 20 is furnished to the vehicle for the purpose of measuring the weight of a passenger, when the passenger is seated in the seat 20. On the basis of the passenger weight measured by the apparatus 10, for example, the seatbelt device, the airbag device, the ECU connected thereto (none of these are illustrated), or the like assesses whether the seated passenger is an adult, a child, or the like. As a result, the seatbelt device, airbag device, or the like is able to provide appropriate protection to the passenger seated in the seat 20.

The applied load value determination unit 13 of the apparatus 10 for measuring a load applied to the sheet 20 determines the weight of the passenger by subtracting a value relating to a load initially applied to the seat 20, from the weight applied to the seat 20 measured by the load sensors 11, e.g., when the passenger is seated in the seat 20. Consequently, when the value relating to a load initially applied to the seat 20 cannot be determined accurately, it will not be possible for the apparatus 10 to accurately measure the weight of the passenger. For this reason, it is particularly preferable to determine an accurate value relating to a load initially applied to the seat 20, after the seat 20 is attached to the vehicle.

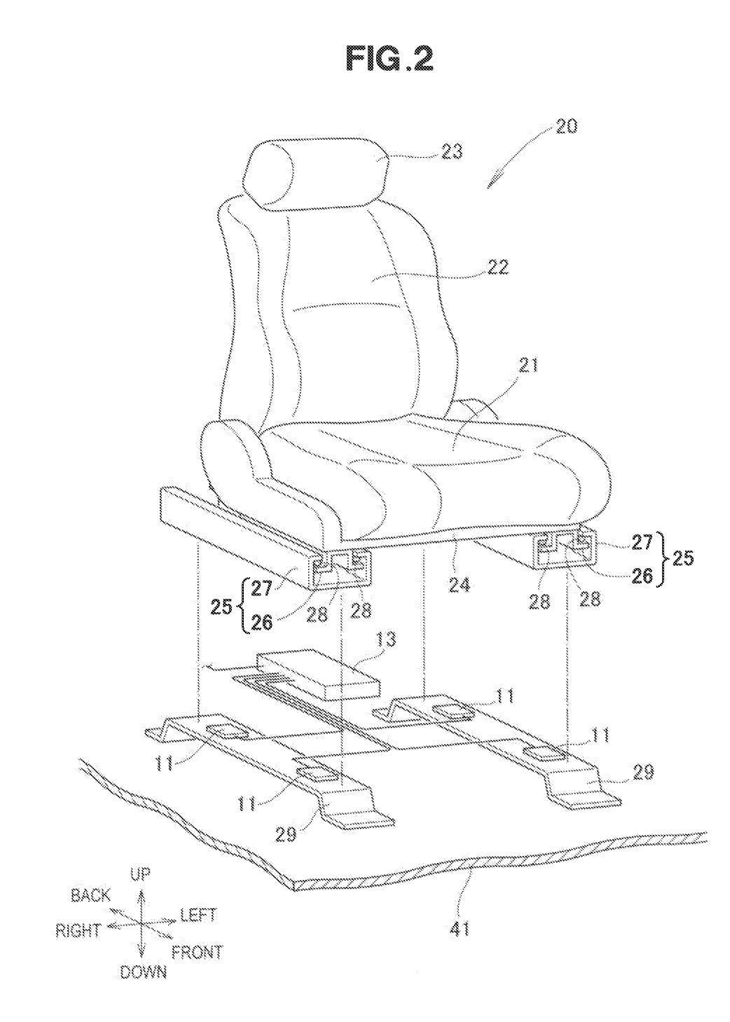

An example of placement of the load sensors 11 will be described using FIG. 2. In the drawing, left and right are expressed with respect to a passenger seated in the seat 20, up and down are expressed with reference to a passenger seated in the seat 20, and vehicle-forward and -rearward directions indicates forward or backward with reference to the direction of vehicle advance.

The seat 20 includes, for example, a seat cushion 21 for supporting the passenger's buttocks and thighs, a seat back 22 reclinably linked to the back end of the seat cushion 21, and adapted for supporting the passenger's lumbar and back, and a headrest 23 supported at the top of the seat back 22, and adapted for supporting the passenger's head and neck. Here, the combination of the seat cushion 21, the seat back 22, and the headrest 23 is referred to as the seat body of the seat 20.

The bottom part and lower side of the side parts of the seat cushion 21 are covered, for example, by a cushion frame 24. The seat body is attached to a vehicle body floor 41 via two seat installation bases 29 constituting a left/right pair attached to the vehicle body floor 41, and two seat rails 25 constituting a left/right pair attached to the cushion frame 24.

The left/right pair of the two seat rails 25 and the left/right pair of the two seat installation bases 29 are identical in constitution between the left side and the right side, and therefore only the right side shall be described.

The right-side seat rail 25 includes an upper rail 26 which is secured to the lower side of the right side of the cushion frame 24, and a lower rail 27 which is secured to the right-side seat installation base 29. The upper rail 26 and the lower rail 27 are assembled so as to be slidable in the vehicle front-back direction, for example. through the agency of two sliding members 28 such as rollers or the like. Therefore, the seat body can slide in the vehicle front-back direction with respect to the vehicle floor 41.

In the example shown in FIG. 2, of the four load sensors 11, two of the load sensors 11 are installed between the right-side seat installation base 29 and the right-side seat rail 25. These two load sensors 11 are installed, for example, with one each positioned towards the vehicle front side and the vehicle back side, between the right-side seat installation base 29 and the right-side seat rail 25. The remaining two load sensors 11 of the four load sensors 11 are installed between the left-side seat installation base 29 and the left-side seat rail 25, as with the right side. The weight of the seat body is applied to each of the four load sensors 11, through one of the corresponding seat rails 25 among the two seat rails 25.

The right-side lower rail 27 is furnished, for example, with at least one lower rail-side through-hole, not shown. The right-side seat installation base 29 is furnished, for example, with at least one seat installation base-side through-hole, not shown. When attaching the seat body to the vehicle floor 41, the seat body is placed on the two seat installation bases 29, in such a way that all of the at least one lower rail-side through-hole furnished to the right-side lower rail 27 and the at least one seat installation base-side through-hole furnished to the right-side seat installation base 29, are aligned. Bolts, not shown, are passed through all of the overlapping lower rail-side through-holes and seat installation base-side through-holes, and are fastened by being screwed into nuts, not shown, attaching the seat body to the vehicle floor 41.

For example, the dimensions of the bolts, nuts, lower rail-side through-holes, and seat installation base-side through-holes may vary when manufactured. There can be envisioned a case in which, before the seat 20 is attached in the vehicle, production error occurs in the amount to which the bolts screw into the nuts. The weight of the seat body applied to at least one of the load sensors 11 will vary due to such production errors. Consequently, it is ideal for the determination of a value relating to a load initially applied to the seat 20 to be performed using bolts, nuts, lower rails, and seat installation bases that are actually used in a vehicle to be sold.

Additionally, when attachment error in the amount to which the bolts screw into the nuts occurs due to the external environment or to operators, there can be envisioned a case in which the weight of the seat body is not applied uniformly to each of the four load sensors 11. In the example shown in FIG. 2, four of the four load sensors 11 are arranged. Consequently, the applied load value determination unit 13, through comprehensive consideration of the output values of all four of the load sensors 11, can reduce or cancel out attachment error, so that the weight of the seat body can be measured with a degree of accuracy.

In cases in which the number of arranged load sensors 11 is not four, for example, there may be envisioned cases in which two of the load sensors 11 are arranged in left-right non-symmetrical fashion. For example, one of the load sensors 11 may be installed towards the front side of the vehicle between the right-side installation base 29 and the right-side seat rail 25, and one of the load sensors 11 may be installed towards the back side of the vehicle between the left-side installation base 29 and the left-side seat rail 25.

In this case, it will be necessary for the applied load value determination unit 13 to determine a value relating to a load initially applied to the seat 20, on the premise that the weight of the seat body is not applied uniformly between the left side and the right side. That is, it will be necessary to accurately measure the weight of the seat body when, for example, the weight of the seat body is not applied uniformly between the left side and the right side. Consequently, in order to accurately determine the value relating to a load initially applied to the seat 20, it is ideal to do so after the seat 20 has been attached to the vehicle 20. The manufacturing cost and weight of the seat 20 or the vehicle can be reduced when the load sensors 11 which are arranged are fewer in number.

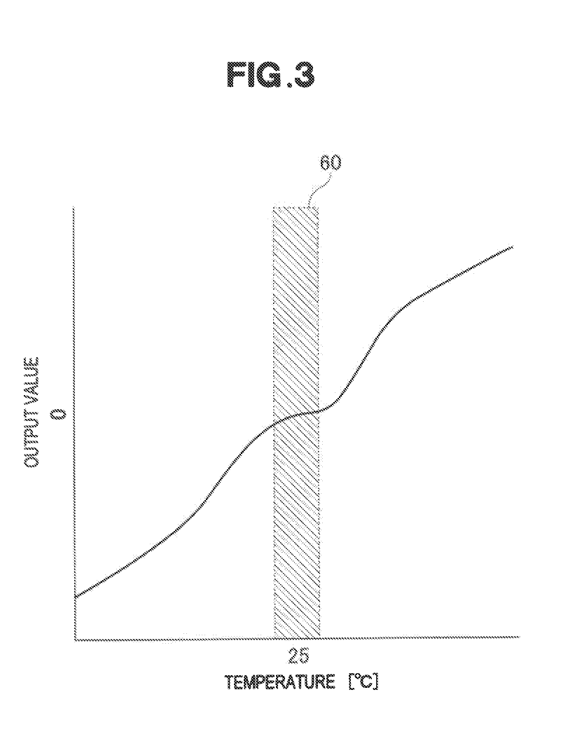

The mechanical properties of the metal, rubber, resin, or the like constituting the load sensors 11 will vary depending on the temperature. As a result, the output values of the load sensors 11 will also vary depending on the temperature. FIG. 3 is a graph showing an example of the relationship between the output values and the temperature of the load sensors 11, in a state in which no load whatsoever is applied to the load sensors 11 (unloaded state). Of course, in an unloaded state, the weight of the seat body is not applied to the load sensors 11 either. In the graph shown in FIG. 3, the horizontal axis plots the temperature of the load sensors 11, and the vertical axis plots the output value of the load sensors 11. Referring to the graph shown in FIG. 3, it may be appreciated that the load sensors 11 have temperature characteristics such that the output value increases as the temperature rises.

In some cases, the correspondence relationship between the output values and the temperature of the load sensors 11 such as that shown in FIG. 3 is unknown. Depending on the temperature characteristics of the load sensors 11, there may be cases in which it is difficult, for example, for the applied load value determination unit 13 to employ a table or computational formula to predict a correspondence relationship between the output values and the temperature of the load sensors 11. Consequently, it is preferable, for example, to determine a value relating to a load initially applied to the seat 20, at a temperature at which the output value of the load sensors 11 is “0,” when the state of the load sensors 11 is the unloaded state. For example, it is ideal for the load sensors 11 to be constituted such that the output value is “0” at normal temperature (e.g., 25° C.). That is, ideally, the applied load value determination unit 13 will determine a value relating to a load initially applied to the seat 20 on the basis of the output values of the load sensors 11, doing so in a state in which the seat 20 has been attached to the vehicle, and the temperature of the load sensors 11 is at normal temperature.

In this instance. when the temperature of the load sensors 11 is within a temperature range that includes normal temperature, the applied load value determination unit 13 may determine a value relating to a load initially applied to the seat 20, on the basis of the output values of the load sensors 11. The prescribed temperature range that includes normal temperature is hereinafter referred to as a first temperature range. The first temperature range is defined within a range of temperature of the load sensors 11, such that in the output values of the load sensors 11, error with respect to the output value “0” of the load sensors 11 is within the permissible range for systems such as the airbag device and the like. That is, the size of the first temperature range is defined according to the temperature characteristics of the load sensors 11. In the graph shown in FIG. 3, the first temperature range is represented by an area 60. In the graph shown in FIG. 3, the first temperature range is defined, for example, as a range of ±15° C. from the normal temperature of 25° C.

When the temperature of the load sensors 11 is within the first temperature range, the applied load value determination unit 13 determines a value relating to a load initially applied to the seat 20, on the basis of the output values of the load sensors 11 at that time. Specifically, for example, in a state with the seat 20 attached to the vehicle, and with the temperature of the load sensors 11 within the first temperature range, the applied load value determination unit 13 determines the output values of the load sensors 11 at that time to be a value relating to a load initially applied to the seat 20.

As a result, the applied load value determination unit 13 can determine an accurate initial applied load value of the seat 20. Consequently, the apparatus 10 can accurately measure the load applied to the seat 20 when a passenger is seated in the seat 20.

The system may be constituted such that, once a value relating to a load initially applied to the seat 20 has been determined, the load sensors 11 output values obtained by subtracting a value relating to a load initially applied to the seat 20 from the measured load value applied to the seat 20. In this case, the load sensors 11 may incorporate a processing unit, a storage unit, and the like, not shown.

The load sensors 11 may be designed such that, in a state in which the weight of the seat body is applied, the output values thereof are “0”. In this case, for example, the value of the load initially applied to the seat 20 may be determined in a state in which the seat 20 has actually been attached to the vehicle, and when the temperature of the load sensors 11 is within the first temperature range, by having the applied load value determination unit 13 correct the output values of the load sensors 11 at this time to “0.”

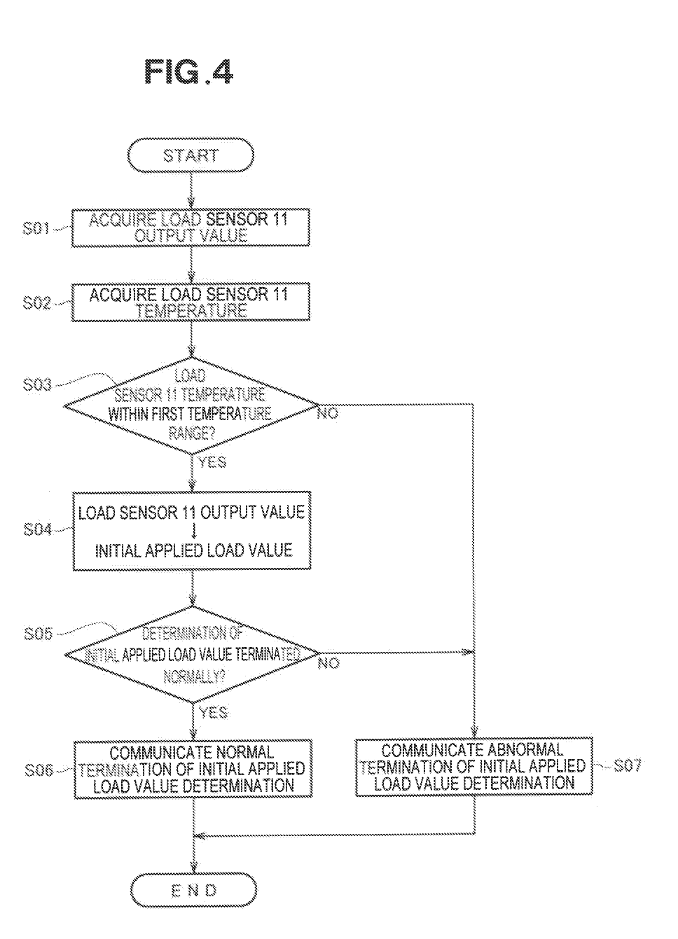

An example of operation to determine a value relating to a load initially applied to the seat 20, performed by the apparatus 10 for measuring a load applied to the seat 20, will be described using the flowchart shown in FIG. 4. This operation takes place, for example, after an operator has attached the seat 20 to the vehicle, and is initiated through a control input to a control input unit, not shown, on the outside of the applied load value determination unit 13 by the operator. The description of the operation below focuses on one of the load sensors 11, but a value relating to a load initially applied to the seat 20 would be determined analogously for the other load sensors 11 as well.

In Step S01, the applied load value determination unit 13 acquires the output value of the load sensor 11.

In Step S02, the applied load value determination unit 13 acquires the temperature of the load sensor 11, detected by the temperature detection unit 12.

In Step S03, the applied load value determination unit 13 assesses whether the temperature of the load sensor 11 acquired in Step S02 is within the first temperature range. When the applied load value determination unit 13 has assessed the temperature of the load sensor 11 as being within the first temperature range, the flow advances to Step S04. On the other hand, when the applied load value determination unit 13 has assessed the temperature of the load sensor 11 as not being within the first temperature range, the flow advances to Step S07.

In Step S04, on the basis of the output value of the load sensor 11 acquired in Step S01, the applied load value determination unit 13 determines a value relating to a load initially applied to the seat 20.

In Step S05, the applied load value determination unit 13 assesses whether the determination of a value relating to a load initially applied to the seat 20 executed in Step S04 terminated normally. When the applied load value determination unit 13 has assessed that the determination of a value relating to a load initially applied to the seat 20 terminated normally, the flow advances to Step S06. On the other hand, when the applied load value determination unit 13 has assessed that the determination of a value relating to a load initially applied to the seat 20 did not terminate normally, the flow advances to Step S07.

In Step S06, the applied load value determination unit 13 communicates that the determination of a value relating to a load initially applied to the seat 20 terminated normally. Specifically, the applied load value determination unit 13, using the communicating unit 17, such as a navigation device display, speaker, indicator, or the like communicates to an operator or the like that the determination of a value relating to a load initially applied to the seat 20 terminated normally. Additionally, the applied load value determination unit 13 may use a display, speaker, indicator, or other communicating unit 17 belonging, for example, to operating equipment, to communicate to the operator, etc., that the determination of a value relating to a load initially applied to the seat 20 terminated normally. Once the fact that determination of the initial applied load value has terminated normally has been communicated, the operation flow terminates.

In Step S07, the applied load value determination unit 13 communicates the fact that determination of a value relating to a load initially applied to the seat 20 terminated abnormally. The specific method of communication is the same as the method for communicating that the determination of the initial applied load value terminated normally, which was described in Step S06. Once it has been communicated that the determination of the initial applied load value terminated abnormally, the operation flow terminates.

By annunciating to the operator the fact that the determination of the initial applied load value terminated normally, or that the determination of the initial applied load value terminated abnormally, the operator can be apprised of the result of the operation to determine the initial applied load value. Consequently, the operator can then decide whether to advance the target vehicle to the next step, or to again execute an operation to determine a value relating to a load initially applied to the seat 20 of the target vehicle.

In the preceding description, the operation to determine a value relating to a load initially applied to the seat 20 is initiated by the operator. However, it would also be acceptable, for example, for the apparatus 10 for measuring a load on the seat 20 to initiate the operation to determine a value relating to a load initially applied to the seat 20, doing so at appropriate timing. Additionally, when the operation to determine a value relating to a load initially applied to the seat 20 has terminated abnormally, i.e., when the assessment in S03 is NO or when the assessment in S05 is NO, the apparatus 10 may, for example, re-initiate the operation to determine the initial applied load value after a predetermined time has passed.

### Second Embodiment

A second embodiment relates to an apparatus 10 for measuring a load applied to the seat 20, the apparatus 10 being provided with load sensors 11 having temperature characteristics that are different from those of the load sensors 11 described in the first embodiment. Consequently, content that duplicates that described in the first embodiment is omitted from the description.

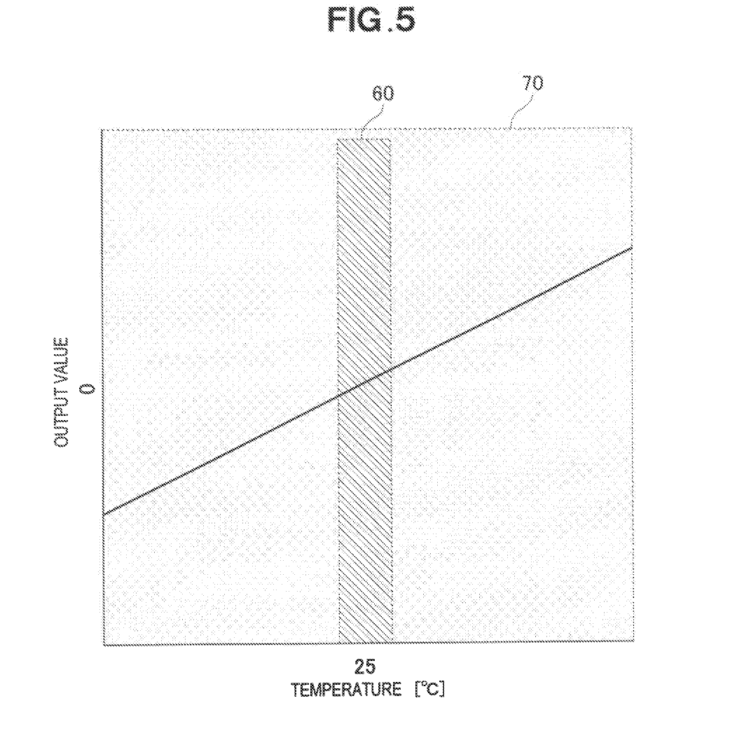

FIG. 5 is a graph showing an example of the relationship between output values and temperature of the load sensors 11, when the load sensors 11 are in an unloaded state. Referring to the graph shown in FIG. 5, it will be apparent that the load sensors 11 have temperature characteristics such that changes in the output values of the load sensors 11 are substantially proportional to changes in temperature.

With the load sensors 11 having the temperature characteristics shown in FIG. 5, the applied load value determination unit 13 can employ, for example, a table or computational formula to readily predict a correspondence relationship between the output values and the temperature of the load sensors 11. Consequently, the applied load value determination unit 13 can readily predict output values of the load sensors 11 when the temperature of the load sensors 11 is normal, even in cases in which the temperature of the load sensors 11 is not normal. Moreover, because the applied load value determination unit 13 employs a table or computational formula, an increase in the amount of processing in relation to prediction of output values of load sensors 11 when the temperature of the load sensor 11 is at normal temperature can be prevented.

The graph shown in FIG. 5 is but one example of temperature characteristics whereby the relationship between output values and temperature of the load sensors 11 can be readily predicted. That is, it is not the case that only temperature characteristics such that changes in the output values of the load sensors 11 are substantially proportional to changes in temperature are temperature characteristics whereby the relationship between output values and temperature of the load sensors 11 can be readily predicted.

In the graph shown in FIG. 5, area 60 represents the first temperature range described in the first embodiment. Hereinbelow, a temperature range that includes the first temperature range, and within which temperature range the output values of the load sensors 11 can be readily predicted throughout the entire range at normal temperature even when the temperature of the load sensors is not within first temperature range, is termed a second temperature range. In the graph shown in FIG. 5, this second temperature range is represented as an area 70, an area that includes the area 60. In the second embodiment, the first temperature range may be established to have a narrower range than the first temperature range in the first embodiment. The first temperature range need not be established in the second embodiment, in which case only the second temperature range would be established.

When the temperature of the load sensors 11 is within the second temperature range, the applied load value determination unit 13 will predict an output value of the load sensors 11 when the temperature of the load sensors 11 is at normal temperature or within the first temperature range. While doing so, the applied load value determination unit 13 also determines a value relating to the load initially applied to the seat 20, on the basis of the predicted output value of the load sensors 11. Specifically, for example, the applied load value determination unit 13 will determine the predicted output value of the load sensors 11 to be the value relating to the load initially applied to the seat 20.

That is, even when the temperature of the load sensors 11 is not within the first temperature range, the applied load value determination unit 13 can accurately determine a value relating to the load initially applied to the seat 20. As a result, even when the temperature of the load sensors 11 is not within the first temperature range, it is unnecessary, for example, for the operator to wait until the temperature of the load sensors 11 reaches normal temperature, or enters the first temperature range, in order to perform a control input initiating an operation to determine a value relating to the load initially applied to the seat 20. Consequently, the time required for the operation to determine a value relating to the load initially applied to the seat 20 can be reduced.

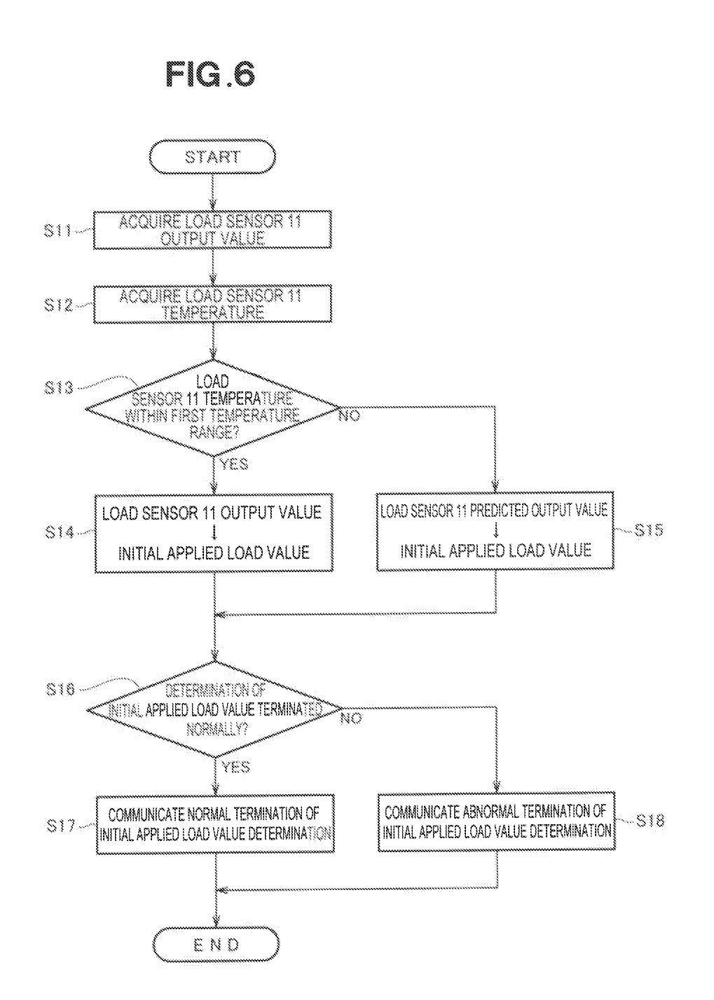

The flowchart shown in FIG. 6 will be employed to describe an example of an operation whereby the apparatus 10 for measuring a load applied to the seat 20 in the second embodiment determines a value relating to a load initially applied to the seat 20. Operation content that duplicates that described in the first embodiment with FIG. 4 is omitted from the description.

Step S11 corresponds to Step S01 in the first embodiment shown in FIG. 4, Step S12 corresponds to Step S02 in the first embodiment shown in FIG. 4, Step S13 corresponds to Step S03 in the first embodiment shown in FIG. 4, and Step S14 corresponds to Step S04 in the first embodiment shown in FIG. 4.

When, in the assessment of Step S13, the applied load value determination unit 13 has assessed the temperature of the load sensors 11 as not being within the first temperature range, i.e., has assessed the temperature of the load sensors 11 as being within the second temperature range, the flow advances to Step S15.

In Step S15, the applied load value determination unit 13, employing the output value of the load sensors 11 that was acquired in Step S11 and the temperature of the load sensors 11 that was acquired in Step S12, predicts an output value of the load sensors 11 when the temperature of the load sensors is at normal temperature or within the first temperature range. On the basis of the predicted output value of the load sensors 11, the applied load value determination unit 13 determines a value relating to a load initially applied to the seat 20.

Step S16 corresponds to Step S05 in the first embodiment shown in FIG. 4, Step S17 corresponds to Step S06 in the first embodiment shown in FIG. 4, and Step S18 corresponds to Step S07 in the first embodiment shown in FIG. 4.

### Third Embodiment

The third embodiment relates to an apparatus 10 for measuring a load applied to the seat 20, the apparatus 10 being provided with load sensors 11 that have different temperature characteristics than the load sensors 11 described in the first embodiment and the load sensors 11 described in the second embodiment. Consequently, content that duplicates that described in the first embodiment or the second embodiment is omitted from the description.

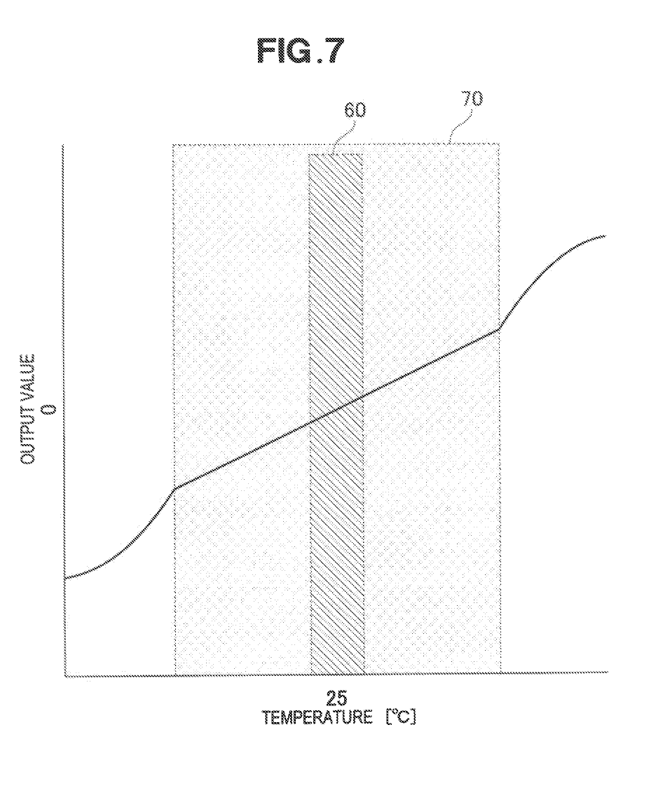

FIG. 7 is a graph showing an example of the relationship between output values and temperature of the load sensors 11, when the state of the load sensors 11 is an unloaded state. Referring to the graph shown in FIG. 7, it will be apparent that the load sensors 11 have temperature characteristics such that changes in the output values of the load sensors 11 are substantially proportional to changes in temperature, throughout the entire range of the area 70 that includes the area 60. The temperature characteristics of the load sensors 11 to a low-temperature side of the area 70 and to a high-temperature side of the area 70 are such that the output value of the load sensors 11 increases in response to rising temperature, but not in a manner proportional to changes in temperature.

With the load sensors 11 having the temperature characteristics shown in FIG. 7, the applied load value determining unit 13, by employing a computational formula or table for example, can readily predict a correspondence relationship between output values and temperature of the load sensors 11, throughout the entire range of the area 70 that includes the area 60. On the other hand, for example, to the low-temperature side of the area 70 and to the high-temperature side of the area 70 shown in FIG. 7, the correspondence relationship between output values and temperature of the load sensors 11 is in some cases unknown. Depending on the temperature characteristics of the load sensors 11, there may be cases in which, for example, it is difficult for the applied load value determining unit 13, employing a computational formula or table, to predict a correspondence relationship between temperature and output values of the load sensors 11, to the low-temperature side of the area 70 and to the high-temperature side of the area 70.

In the graph shown in FIG. 7, the area 60 is the first temperature range that was described in the first embodiment. The area 70 is the second temperature range that was described in the second embodiment. That is, the low-temperature side of the area 70 and the high-temperature side of the area 70 are neither in the first temperature range nor the second temperature range. In the third embodiment, as in the second embodiment, the first temperature range may be narrower than the first temperature range of the first embodiment. In the third embodiment, as in the second embodiment, the first temperature range need not be established, in which case only the second temperature range would be established.

In cases in which the temperature of the load sensors 11 is within the second temperature range, the applied load value determining unit 13 predicts an output value of the load sensors 11, when the temperature of the load sensors 11 is at normal temperature or within the first temperature range. While doing so, the applied load value determination unit 13 also determines the value relating to the load initially applied to the seat 20, on the basis of the predicted output value of the load sensors 11. That is, when the temperature of the load sensors 11 lies within the first temperature range or the second temperature range, the applied load value determining unit 13 can accurately determine the value relating to the load initially applied to the seat 20. As a result, when the temperature of the load sensors 11 is within the second temperature range, it is unnecessary, for example, for the operator to wait until the temperature of the load sensors 11 reaches normal temperature, or enters the first temperature range, in order to initiate an operation to determine a value relating to a load initially applied to the seat 20. Consequently, when the temperature of the load sensors 11 is within the second temperature range, the time required for the operation to determine a value relating to a load initially applied to the seat 20 can be reduced.

On the other hand, in cases in which the temperature of the load sensors 11 lies to the low-temperature side of the area 70 or the high-temperature side of the area 70, which are temperature ranges in which it is difficult to predict the correspondence relationship between output values and temperature of the load sensors 11, the applied load value determination unit 13 does not determine the value relating to the load initially applied to the seat 20. Consequently, inaccurate determination of the initial applied load of the seat 20 is prevented.

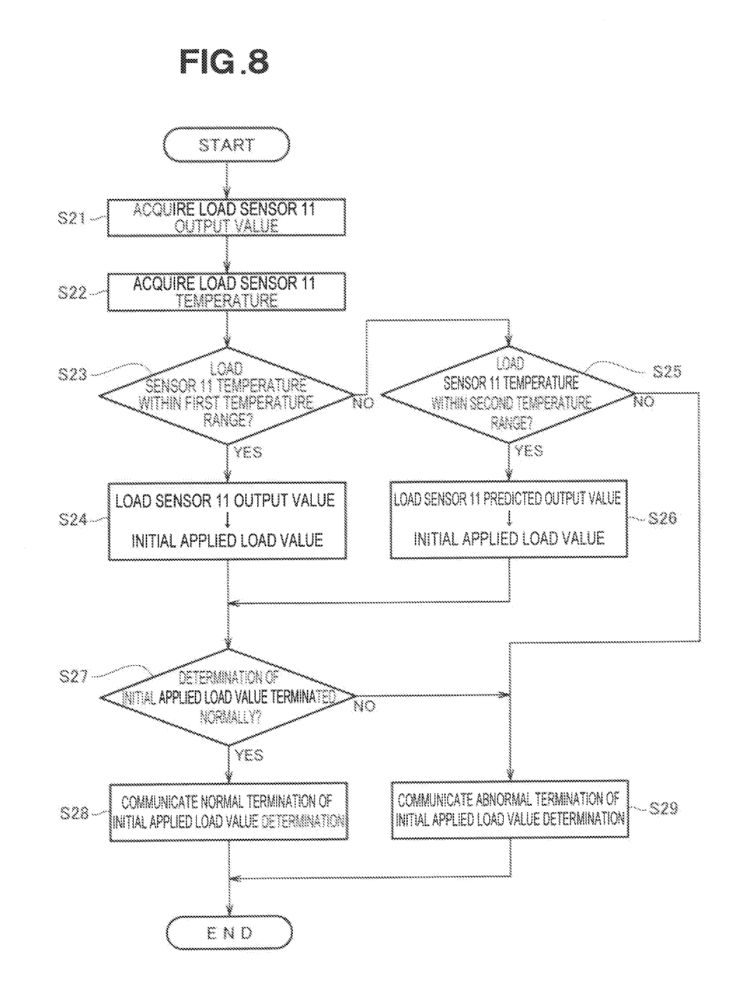

The flowchart shown in FIG. 8 will be employed to describe an example of an operation whereby the apparatus 10 for measuring a load applied to the seat 20 in the third embodiment determines a value relating to a load initially applied to the seat 20. Operation content that duplicates that described in the first embodiment with FIG. 4 or is operation content that duplicates that described in the second embodiment with FIG. 6 is omitted from the description.

Step S21 corresponds to Step S01 in the first embodiment shown in FIG. 4, Step S22 corresponds to Step S02 in the first embodiment shown in FIG. 4, Step S23 corresponds to Step S03 in the first embodiment shown in FIG. 4, and Step S24 corresponds to Step S04 in the first embodiment shown in FIG. 4.

When, in the assessment of Step S23, the applied load value determination unit 13 has assessed the temperature of the load sensors 11 as not being within the first temperature range, the flow advances to Step S25.

In Step S25, the applied load value determination unit 13 assesses whether the temperature of the load sensors 11 acquired in Step S22 is within the second temperature range. When the applied load value determination unit 13 assesses the temperature of the load sensors 11 to be within the second temperature range, the flow advances to Step S26. On the other hand, when the applied load value determination unit 13 assesses the temperature of the load sensors 11 to not be within the second temperature range, the flow advances to Step S29.

Step S26 corresponds to Step S15 in the second embodiment shown in FIG. 6, Step S27 corresponds to Step S05 in the first embodiment shown in FIG. 4, Step S28 corresponds to Step S06 in the first embodiment shown in FIG. 4, and Step S29 corresponds to Step S07 in the first embodiment shown in FIG. 4.

The present disclosure is not limited to the exemplary embodiments set forth hereinabove, and modifications to the exemplary embodiments set forth hereinabove could easily be made by a person skilled in the art, without departing from the scope of the claims.

What is claimed is:

1. An apparatus for measuring a load applied to a seat, the apparatus comprising:
a load sensor furnished to the seat, and capable of outputting the load and a weight of the seat;
a temperature detection unit for detecting a temperature of the load sensor; and
an applied load value determination unit for determining a load applied to the seat, according to an output value of the load sensor,
the applied load value determination unit determining a value relating to a load initially applied to the seat, based on the output value of the load sensor when the temperature of the load sensor is within a first temperature range including a predetermined temperature.

2. The apparatus of claim 1, wherein
when the detected temperature of the load sensor lies within a second temperature range, which includes the first temperature range and within which association of temperatures of the load sensor and output values of the load sensor is possible throughout the entire range, the applied load value determination unit
predicts an output value of the load sensor in the event that the temperature of the load sensor is at the predetermined temperature, or lies within the first temperature range, and
determines a value relating to a load initially applied to the seat, based on the predicted output value of the load sensor.

3. The apparatus of claim 2, wherein the applied load value determining unit, by employing a computational formula or table by which association of temperatures of the load sensor and output values of the load sensor is possible, predicts an output value of the load sensor in the event that the temperature of the load sensor is at the predetermined temperature, or lies within the first temperature range.

4. The apparatus of claim 1, wherein subsequent to attachment of the seat to a vehicle, the applied load value determining unit determines a value relating to a load initially applied to the seat, based on the output value of the load sensor when the temperature of the load sensor is within the first temperature range.
